(19) United States
(12) Patent Application Publication
(10) Pub. No.: US 2026/0202592 A1
(43) Pub. Date: Jul. 16, 2026

(54) Backfilled Evacuated Periodic Structures and Methods of Manufacture

(71) Applicant: DigiLens Inc., Sunnyvale, CA (US)

(72) Inventors: Hyesog Lee, Sunnyvale, CA (US); Alastair John Grant, San Jose, CA (US); Baeddan George Hill, Sunnyvale, CA (US); Gerald Buxton, Sunnyvale, CA (US); Yuyu Li, Sunnyvale, CA (US); Gang Li, Sunnyvale, CA (US); Joseph Stephen Thomas Smalley, Sunnyvale, CA (US)

(73) Assignee: DigiLens Inc., Sunnyvale, CA (US)

(21) Appl. No.: 19/134,652

(22) PCT Filed: Dec. 4, 2023
(86) PCT No.: PCT/IB2023/000782

§ 371 Date: May 30, 2025

Related U.S. Application Data
(60) Provisional application No. 63/385,863, filed on Dec. 2, 2022.

(51) Int. Cl. G02B 5/18; G02B 1/11; G02B 6/12; G02B 6/124; G02B 6/132; G02B 6/136

(52) U.S. Cl. CPC G02B 5/1857; G02B 6/124; G02B 6/132; G02B 6/136; G02B 1/11; G02B 2006/12107; G02B 2006/12176

(57) ABSTRACT

Disclosed herein is a method for recording a grating structure and the resultant grating structure. In one example, the method includes: depositing a holographic mixture containing a mixture of monomer and inert material onto a first substrate; exposing the holographic mixture to form a nanostructure including polymer-rich and inert-material rich regions using a holographic exposure phase separation process; removing the inert material from the inert material rich regions to form a grating including polymer rich regions and regions containing a residual polymer network; applying an ashing process to the regions containing a residual polymer network to form an ashed grating comprising polymer-rich regions and air regions; depositing a coating material onto the ashed grating to form a coated grating where the coating material backfills the air regions and overcoats the polymer-rich regions.

### CROSS-REFERENCED APPLICATIONS

This application claims priority to U.S. Provisional Application 63/385,863 filed on Dec. 2, 2022, the disclosure of which is incorporated by reference in its entirety.

### FIELD OF THE INVENTION

The present invention generally relates to backfilled surface relief gratings and more specifically backfilled evacuated periodic structures.

### BACKGROUND

Waveguides can be referred to as structures with the capability of confining and guiding waves (i.e., restricting the spatial region in which waves can propagate). One subclass includes optical waveguides, which are structures that can guide electromagnetic waves, typically those in the visible spectrum. Waveguide structures can be designed to control the propagation path of waves using a number of different mechanisms. For example, planar waveguides can be designed to utilize diffraction gratings to diffract and couple incident light into the waveguide structure such that the in-coupled light can proceed to travel within the planar structure via total internal reflection (TIR).

Fabrication of waveguides can include the use of material systems that allow for the recording of holographic optical elements within or on the surface of the waveguides. One class of such material includes polymer dispersed liquid crystal (PDLC) mixtures, which are mixtures containing photopolymerizable monomers and liquid crystals. A further subclass of such mixtures includes holographic polymer dispersed liquid crystal (HPDLC) mixtures. Holographic optical elements, such as volume phase gratings, can be recorded in such a liquid mixture by illuminating the material with two or more mutually coherent laser beams. During the recording process, the monomers polymerize, and the mixture undergoes a photopolymerization-induced phase separation, creating regions densely populated by liquid crystal (LC) micro-droplets, interspersed with regions of clear polymer. The alternating liquid crystal-rich and liquid crystal-depleted regions form the fringe planes of the grating.

Waveguide optics, such as those described above, can be considered for a range of display systems and sensor applications. In many applications, waveguides containing one or more grating layers encoding multiple optical functions can be realized using various waveguide architectures and material systems, enabling new innovations in near-eye displays for Augmented Reality (AR) and Virtual Reality (VR), compact Heads Up Displays (HUDs) for aviation and road transport, and sensors for biometric and laser radar (LIDAR) applications. As many of these applications are directed at consumer products, there is a growing requirement for efficient low cost means for manufacturing holographic waveguides in large volumes.

### SUMMARY OF THE INVENTION

In some aspects, the techniques described herein relate to a method for recording a grating structure, the method including: depositing a holographic mixture containing a mixture of monomer and inert material onto a first substrate; exposing the holographic mixture to a holographic recording beam to form a volume grating including polymer-rich regions and inert-material rich regions; removing the inert material from the inert material rich regions to form an evacuated periodic structure including polymer rich regions and regions containing a residual polymer network; applying an ashing process to the regions containing a residual polymer network to form an ashed grating including polymer-rich regions and air regions; depositing a coating material onto the ashed grating to form a final grating where the coating material backfills the air regions and overcoats the polymer-rich regions.

In some aspects, the techniques described herein relate to a method, wherein the coating material is a chemical compound of silicon and nitrogen.

In some aspects, the techniques described herein relate to a method, wherein the coating material is silicon nitride (Si3N4) applied with a minimum thickness greater than 200 nm.

In some aspects, the techniques described herein relate to a method, wherein the coating material has an index greater than that of the polymer.

In some aspects, the techniques described herein relate to a method, wherein the coating material has an index lower than that of the polymer.

In some aspects, the techniques described herein relate to a method, wherein the coating material is a composite of more than one material.

In some aspects, the techniques described herein relate to a method, wherein depositing the coating material includes more than one coating steps.

In some aspects, the techniques described herein relate to a method, wherein the coating material includes nanoparticles.

In some aspects, the techniques described herein relate to a method, wherein the final grating is a slanted grating.

In some aspects, the techniques described herein relate to a method, wherein the final grating is a photonic crystal.

In some aspects, the techniques described herein relate to a method, further including depositing an antireflection coating to the final grating.

In some aspects, the techniques described herein relate to a method, wherein depositing the coating material includes a plasma enhanced chemical vapor deposition (PECVD) process.

In some aspects, the techniques described herein relate to a method, further including covering the coating material with a second substrate with an upper surface in contact with air and a lower surface supporting a release layer placed in contact with the coating material.

In some aspects, the techniques described herein relate to a method, wherein depositing the coating material includes an atomic layer deposition (ALD) process.

In some aspects, the techniques described herein relate to a method, wherein depositing the coating material includes suffusing a portion of the coating material into pores contained within the polymer rich regions.

In some aspects, the techniques described herein relate to a method, wherein the final grating includes a volume phase grating (VPG) including alternating polymer-rich regions and coating material rich regions overlaid by a surface relief grating (SRG) formed from the coating material, wherein the maxima of the SRG overlay the polymer rich regions of the VPG and wherein the minima of the SRG overlay the coating material rich regions of the VPG.

In some aspects, the techniques described herein relate to a method, wherein the VPG is a volume Bragg grating (VBG).

In some aspects, the techniques described herein relate to a method, wherein the holographic mixture contacting surface of the first substrate is modified by at least one selected from the group consisting of: nano-structuring, chemical functionalisation, and coating.

In some aspects, the techniques described herein relate to a method, wherein the coating partially backfills the air regions such that a portion of the air regions still exists between adjacent portions of the coating overlaying adjacent polymer rich regions.

In some aspects, the techniques described herein relate to a method, wherein the coating contacts the first substrate in sections between adjacent polymer rich regions.

In some aspects, the techniques described herein relate to a method, further including depositing a backfill material above the coating contacting the first substrate in sections between adjacent polymer rich regions to backfill the air regions between adjacent portions of the coating.

In some aspects, the techniques described herein relate to a method, wherein the backfill material partially backfills the air regions between adjacent portions of the coating such that air regions still exist between adjacent portions of the coating above the backfill material.

In some aspects, the techniques described herein relate to a method, wherein the backfill material includes a high index resin.

In some aspects, the techniques described herein relate to a method, wherein depositing the backfill material includes drop casting, spin coating, slot-die coating, or spray-coating.

In some aspects, the techniques described herein relate to a method, further including curing the deposited backfill material.

In some aspects, the techniques described herein relate to a method, wherein the coating includes an inorganic material.

In some aspects, the techniques described herein relate to a method, wherein the coating includes Al2O3, TiO2, and/or HfO2.

In some aspects, the techniques described herein relate to a method, wherein depositing the coating material includes an atomic layer deposition technique.

In some aspects, the techniques described herein relate to a grating structure including: a substrate; a repeating pattern of polymer regions positioned on the substrate; a coating which conformally coats the exposed surfaces of the polymer regions and the substrate; and a backfill material which occupies the regions between adjacent portions of the coating.

In some aspects, the techniques described herein relate to a grating structure, wherein the coating contacts the substrate in sections between adjacent polymer regions.

In some aspects, the techniques described herein relate to a grating structure, wherein the backfill material partially backfills the regions between adjacent portions of the coating such that air regions exist between adjacent portions of the coating above the backfill material.

In some aspects, the techniques described herein relate to a grating structure, wherein the backfill material includes a high index resin.

In some aspects, the techniques described herein relate to a grating structure including: a substrate; a repeating pattern of polymer regions positioned on the substrate; a coating which conformally coats the exposed surfaces of the polymer regions and the substrate, wherein the coating completely fills the sections between the polymer regions and extends beyond the tops of polymer regions such that a final grating is formed including a volume phase grating (VPG) including alternating polymer-rich regions and coating material rich regions overlaid by a surface relief grating (SRG) formed from the coating material, wherein the maxima of the SRG overlay the polymer rich regions of the VPG and wherein the minima of the SRG overlay the coating material rich regions of the VPG.

In some aspects, the techniques described herein relate to a grating structure, wherein the coating is a chemical compound of silicon and nitrogen.

In some aspects, the techniques described herein relate to a grating structure, wherein the coating material is silicon nitride (Si3N4) applied with a minimum thickness greater than 200 nm.

In some aspects, the techniques described herein relate to a grating structure, wherein the coating has an index greater than that of the polymer regions.

In some aspects, the techniques described herein relate to a grating structure, wherein the coating has an index lower than that of the polymer regions.

In some aspects, the techniques described herein relate to a grating structure, wherein the coating is a composite of more than one material.

In some aspects, the techniques described herein relate to a grating structure, wherein the coating includes nanoparticles.

In some aspects, the techniques described herein relate to a grating structure, wherein the polymer regions are slanted to create a slanted grating.

In some aspects, the techniques described herein relate to a grating structure, further including an antireflection overlaying the coating.

In some aspects, the techniques described herein relate to a grating structure, further including a second substrate with an upper surface in contact with air and a lower surface supporting a release layer placed in contact with the coating material.

In some aspects, the techniques described herein relate to a grating structure, wherein the coating is suffused into pores contained within the polymer regions.

In some aspects, the techniques described herein relate to a method for fabricating a diffractive waveguide including the steps of: coating a holographic mixture including an inert component and a monomer component onto a first substrate; exposing the holographic mixture to a holographic recording beam to form a volume grating including polymer rich regions separated by inert component regions; removing at least a portion of the inert component from the volume grating to form an evacuated periodic structure including polymer rich regions separated by air regions; depositing a first high index material onto the polymer structure using a dry deposition process; and depositing a second high index material onto the first high index material using a liquid deposition process.

In some aspects, the techniques described herein relate to a method, wherein the polymer structure is a surface relief diffractive structure.

In some aspects, the techniques described herein relate to a method, wherein the inert component includes liquid crystal, inert fluid and/or nanoparticles.

In some aspects, the techniques described herein relate to a method, wherein the first high index material is inorganic.

In some aspects, the techniques described herein relate to a method, wherein the first high index material includes multiple layers.

In some aspects, the techniques described herein relate to a method, wherein the multiple layers includes different materials.

In some aspects, the techniques described herein relate to a method, wherein the multiple layers include different thicknesses.

In some aspects, the techniques described herein relate to a method, wherein the dry deposition process is one selected from the group consisting of: Atomic Layer Deposition (ALD), Chemical Vapor Deposition (CVD), Plasma-Enhanced Chemical Vapor Deposition (PECVD), and Metal-Organic Chemical Vapor Deposition (MOCVD).

In some aspects, the techniques described herein relate to a method, wherein the second high index material is a resin.

In some aspects, the techniques described herein relate to a method, wherein the liquid deposition process selected from the group consisting of: drop casting, spin coating, slot die coating, and spray coating.

In some aspects, the techniques described herein relate to a method, wherein depositing the second high index material includes using solution including a solvent.

In some aspects, the techniques described herein relate to a method, wherein the second high index material is coated onto the structure resulting from applying the dry deposition process to the polymer structure to provide air spaces above the second high index material surrounded by adjacent portions of the first high index material.

In some aspects, the techniques described herein relate to a method, wherein the second high-index material at least partially fills air gaps between adjacent regions of the first high index material which are present after applying the dry deposition process to the polymer structure.

In some aspects, the techniques described herein relate to a method, wherein the second high-index material completely immerses the structure resulting from applying the dry deposition process to the polymer structure.

In some aspects, the techniques described herein relate to a method, wherein the second high-index material planarizes the structure resulting from applying the dry deposition process to the polymer structure.

In some aspects, the techniques described herein relate to a method, further including positioning a second substrate on the second high-index material, wherein the second high-index material bonds the second substrate to the structure resulting from applying the dry deposition and liquid deposition processes to the polymer structure.

In some aspects, the techniques described herein relate to a method, further including overlaying a second substrate over the structure resulting from applying the dry deposition and liquid deposition processes to the polymer structure.

In some aspects, the techniques described herein relate to a method, further including depositing a release layer onto the second substrate which facilitates the removal of the second substrate.

In some aspects, the techniques described herein relate to a method, further including applying a thermal reflow process to the polymer structure.

In some aspects, the techniques described herein relate to a diffractive waveguide including: a first substrate; a polymer structure formed on the first substrate including polymer fringes; a first high index material layer conformally coating the polymer fringes; a second high index material layer occupying the space between adjacent portions of the first high index material layer.

In some aspects, the techniques described herein relate to a diffractive waveguide, wherein the second high index material completely fills in the sections between adjacent portions of the first high index material layer and includes a planarization layer above the height of the first high index material to planarize the polymer structure.

In some aspects, the techniques described herein relate to a diffractive waveguide, further including a second substrate overlaying the planar surface of the second high index material.

In some aspects, the techniques described herein relate to a diffractive waveguide, wherein the first high index material layer includes an inorganic material and the second high index material layer includes an organic material.

In some aspects, the techniques described herein relate to a diffractive waveguide, wherein the first high index material and the second high index material have a higher diffractive index than the polymer structure.

In some aspects, the techniques described herein relate to a diffractive waveguide, wherein the polymer fringes are slanted.

In some aspects, the techniques described herein relate to a diffractive waveguide, wherein the polymer fringes have a depth in the range 1-3 micrometers and a fringe spacing in the range of 0.35 to 0.80 micrometers.

In some aspects, the techniques described herein relate to a diffractive waveguide, wherein the polymer fringes have a ratio of depth to fringe spacing in the range of 1:1 to 5:1.

In some aspects, the techniques described herein relate to a diffractive waveguide including: a first substrate; a polymer structure formed on the first substrate including polymer fringes; a first high index material layer occupying the space between adjacent polymer fringes; and a second high index material layer conformally coating the exposed portions of the polymer fringes and the first high index material layer.

In some aspects, the techniques described herein relate to a diffractive waveguide, wherein the first high index material includes an organic material and the second high index material layer includes an inorganic material.

In some aspects, the techniques described herein relate to a method for fabricating a diffractive waveguide including the steps of: coating a holographic mixture including an inert component and a monomer component onto a first substrate; exposing the holographic mixture to a holographic recording beam to form a volume grating including polymer rich regions separated by inert component regions; removing at least a portion of the inert component from the volume grating to form an evacuated periodic structure including polymer rich regions separated by air regions; depositing a first high index material onto the polymer structure using a liquid deposition process; and depositing a second high index material onto the first high index material using a dry deposition process.

### BRIEF DESCRIPTION OF THE DRAWINGS

The description will be more fully understood with reference to the following figures and data graphs, which are presented as various embodiment of the disclosure and should not be construed as a complete recitation of the scope of the disclosure, wherein:

FIG. 1 is a cross-sectional schematic of a backfilled EPS structure in accordance with an embodiment of the invention.

FIG. 2 is a flow chart of a method of fabricating a backfilled nanostructure in accordance with an embodiment of the invention.

FIGS. 3A-3E illustrate an example process flow for fabricating deep SRGs in accordance with an embodiment of the invention.

FIG. 4 is a schematic illustration of a backfilling method which may be utilized on the polymer-air SRGs described in FIG. 3E in accordance with an embodiment of the invention.

FIG. 5A is an SEM image of an example post-ashed EPS grating.

FIG. 5B is a diffraction efficiency (DE) versus angle plot for S-polarized light.

FIG. 5C is a DE versus angle plot for P-polarized light.

FIG. 6A is an SEM image of an example post-ashed EPS grating.

FIG. 6B is a DE versus angle plot for S-polarized light.

FIG. 6C is a DE versus angle plot for P-polarized light.

FIG. 7A is an image of an example grating.

FIG. 7B is a DE versus angle plot for S-polarized light of the grating of FIG. 7A.

FIG. 7C is a DE versus angle plot for P-polarized light of the grating of FIG. 7A.

FIG. 8A shows the percentage DE across versus angle for an ALD coated grating for ALD coating thicknesses in the range 0 -50 nm.

FIG. 8B shows the percentage DE across versus angle for an PECVD SiN coated grating for ALD coating thicknesses in the range 0 -500 nm.

FIG. 8C is a graph that aggregates the coating thickness versus angle characteristics in the ALD regime and in the SIN PECVD regime for a completely backfilled grating.

FIG. 9 illustrates an example nanostructure fabrication process in accordance with an embodiment of the invention.

FIG. 10 is a cross-sectional view of a surface relief grating structure in accordance with an embodiment of the invention.

FIG. 11 is a cross-sectional view of the grating of FIG. 10 after a high index coating 1011 has been applied in accordance with an embodiment of the invention.

FIG. 12 is a cross-sectional view of the grating of FIG. 11 after partial backfilling with a high index material.

FIG. 13 is a cross-sectional view of the grating of FIG. 11 after totally immersion in the high-index material.

FIG. 14 is a cross-sectional view of the grating of FIG. 11 with the polymer structure conformally coated with the first high-index material, conformally coated with a second high-index material.

FIGS. 15-17 illustrate further configurations of the second high-index material of FIG. 14.

FIG. 18 is a cross sectional view of the grating structure of FIG. 14 that is partially backfilled with a third refractive index material in accordance with an embodiment of the invention.

FIG. 19 is a cross-sectional view of the grating structure of FIG. 14 that is completely immersed in the third refractive index material which provides a planar top surface.

FIG. 20 is a cross-sectional view of the grating structure of FIG. 19 where a second substrate is bonded to the planar surface of the third h refractive index material.

FIG. 21 is a cross-sectional view of the grating structure of FIG. 14 where a third refractive index material is conformally coated on the second high refractive index material.

FIGS. 22-24 illustrate three stages of diffractive waveguide fabrication using a dry immersion processes.

FIG. 25 illustrates a liquid deposition process performed on a grating structure in accordance with an embodiment of the invention.

FIG. 26 is a flow chart conceptually illustrating a method of fabricating an immersed surface relief polymer structure in accordance with an embodiment of the invention.

### DETAILED DESCRIPTION

Various disclosed embodiments are directed at backfilled evacuated periodic structure (EPS) and methods for making backfilled gratings described by way of example with reference to the accompanying drawings. EPSs are described in U.S. Pat. No. 11,442,222, entitled “Evacuated gratings and methods of manufacturing” and filed Aug. 28, 2020 which is hereby incorporated by reference in its entirety.

The field of view (FOV) and spectral information that can be carried by a waveguide is determined by the lowest refractive index in the structure. Polymeric materials currently used in the manufacture of surface relief gratings (SRGs) may not achieve the high indices needed for simultaneous high angular bandwidth and full color. Disclosed herein are methods for introducing high index materials (resins) into a polymer waveguide structure to including a liquid deposition of the resin, and/or a dry deposition of inorganic material (e.g. using ALD or other processes) These ‘immersion’ processes may enable wider FOV and/or improved RGB coverage with reduced numbers of waveguides per AR display eyepiece. A release coatings may be applied to any of the substrates used in the waveguide according to recording geometry and which substrate may be released in order to perform processing of the initially recorded volume diffractive structure (e.g. VBG) into a surface relief structure. The substrates can have any thickness depending on the design but typically they are <1 mm. Various fabrication steps described in the reference documents may be applied to form well defined surface relief gratings using phase separation. These process may include solvent-washing of phase-separated materials and dry etching to clear the grooves of any organic residue. Various methods for applying the resin and can be used such as, drop-casting, spin-coating, slot-die coating, spray-coating etc.

Although the description addresses immersion of gratings formed by phase separation process this is merely exemplary. The various methods disclosed may also be applied to gratings formed using nano-lithographical processes which may form surface relief gratings. Thus, after a grating structure is created through any process, it has been discovered that a backfilling process may be produce advantageous results. The grating structure may be a deep surface relief grating. Examples of deep SRGs are described in U.S. Pat. No. 11,442,222 which is incorporated by reference above. Deep SRGs, may have a thickness in the range 1-3 micrometers with a Bragg fringe spacing of 0.35 to 0.80 micrometers. In some embodiments, the ratio of grating depth (thickness) to Bragg fringe spacing may be 1:1 to 5:1.

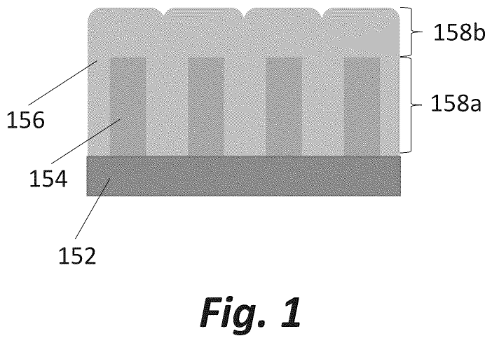

In some examples, a backfilling method may be utilized after creating the EPS. The backfilling method may include depositing a silicon nitride (Si₃N4) layer on top of the EPS to form a backfilled nanostructure. FIG. 1 is a cross-sectional schematic of a backfilled EPS structure in accordance with an embodiment of the invention. An EPS structure 154 may be positioned on a substrate 152. The substrate may have a refractive index of n=1.5-2.0. The EPS structure 154 may including alternative polymer sections of refractive index of n=1.5. A conformal coating 156 may be formed on the EPS structure 154. The EPS structure 154 may be 400nm thick. The conformal coating 156 may be a SiₓN_{y} coating. The conformal coating 156 may extend above the EPS structure 154 by 200nm. The refractive index of the conformal coating 156 may be n=2.0. The conformal coating 156 may completely fill in the sections between the EPS structure 154. In some examples, the conformal coating 156 may not completely fill the sections between the EPS structure 154 such that there is air left between adjacent sections of the conformal coating 156.

The grating may include a volume phase grating (VPG) 158a including polymer sections and coating regions. The VPG 158a may be overlaid by a surface relief grating (SRG) 158b formed from the conformal coating 156. The minima of the SRG overlay the polymer sections of the VPG and the maxima of the SRG overlay the coating regions of the VPG.

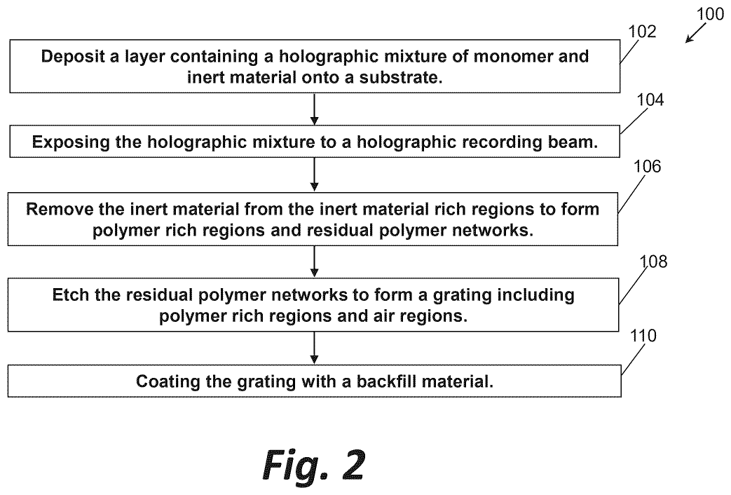

FIG. 2 is a flow chart of a method of fabricating a backfilled nanostructure in accordance with an embodiment of the invention. The method 100 includes depositing 102 a layer containing a holographic mixture of monomer and inert material onto a substrate. The method 100 further includes exposing 104 the holographic mixture to a holographic recording beam. The holographic recording beam may produce a nanostructure including polymer-rich and inert-material rich regions. The holographic recording beam may produce phase separation within the holographic mixture. The method 100 further includes removing 106 the inert material from the inert material rich regions. The remaining nanostructure may include polymer rich regions and regions containing a residual polymer network. The method 100 further includes etching 108 the remaining nanostructure. The etching 108 may be a plasma etching (e.g. ashing) step. Some residual polymer network may be removed to form a grating including polymer-rich regions and air regions. The etching 108 may better define the polymer-rich regions to create a polymer grating structure. The method 100 further includes coating 110 the grating with a backfill material. The backfill material may be deposited onto the polymer rich regions and the sidewalls of the polymer-rich regions. The backfill material may also replace the air regions such that a grating is produced of alternating polymer-rich regions and backfill material. An example backfilled EPS structure is illustrated in described in connection with FIG. 1.

In many embodiments, the inert material used in the holographic mixture is liquid crystal.

In many embodiments, the backfill material may be a chemical compound of the elements Silicon and Nitrogen. In many embodiments, the coating material may be SiN applied with a minimum thickness greater than 200nm.

In some embodiments, the backfill material may be zirconia and/or titania (e.g. titanium dioxide).

In various embodiments, the coating material may have an index greater than that of the polymer rich regions or lower than that of the polymer rich regions.

In many embodiments, the coating material may be a composite of more than one material. In many embodiments, the coating material may include nanoparticles. In many embodiments, the more than one material is deposited in more than one coating steps. In many embodiments, the coating material may be deposited using a PECVD process. In many embodiments, the coating material may be deposited using an ALD process. In many embodiments, depositing the coating material includes suffusing a portion of the coating material into pores contained within the polymer rich regions. The suffusion of the pores with the coating material may occur during depositing the coating material. However, in some cases exposure of the polymer regions to a further material (e.g. by immersing the structure in a bath of the material, for example) or a thermal stimulus may be used to condition the pores to aid suffusion.

In many embodiments, the holographic mixture contacting surface of the substrate may include at least one of: nano-structuring, chemical functionalisation, and/or coating. The substrate surface in contact with the holographic mixture layer may include at least one of: nano-structuring, chemical functionalization, and/or coating.

In some embodiments, the coating may be applied to any type of surface relief nanostructure, including unslanted gratings, slanted gratings and photonic crystals in general. In many embodiments, a cell is formed by covering the coating material with a second substrate with a release layer applied to its lower surface which is in contact with the coating material. Many embodiments may include a further step of applying an antireflection coating.

In some embodiments, a grating structure may be recorded without sandwiching the holographic material between first and second substrates. In such embodiments the second substrate may be applied to the top of the nanostructure after deposition of the coating material. In such embodiments, the second substrate may also support a release layer. The second substrate may be applied as a protective layer to the top of the previously recorded nanostructure. In some embodiments, where the protective layer is for temporary use, the second substrate may support a release layer to allow for the removal after the holographic exposure process.

In many embodiments, the nanostructure formed after deposition of the coating material comprises a volume phased grating (VPG) having alternating polymer-rich and coating material rich regions overlaid by a surface relief grating (SRG) formed from the coating material. The VPG may be a volume Bragg grating (VBG). The minima of the SRG overlays the polymer rich regions of the VBG and the maxima of the SRG overlays the coating material rich regions of the VBG. In many embodiments, the combination of the diffractive properties of the SRG (e.g. wide angular response) and the diffractive properties of the VPG (e.g. high diffraction efficiency around the Bragg condition) may provide a hybrid grating with enhanced angular, polarization and spectral response characteristics that can be tuned for a range of applications.

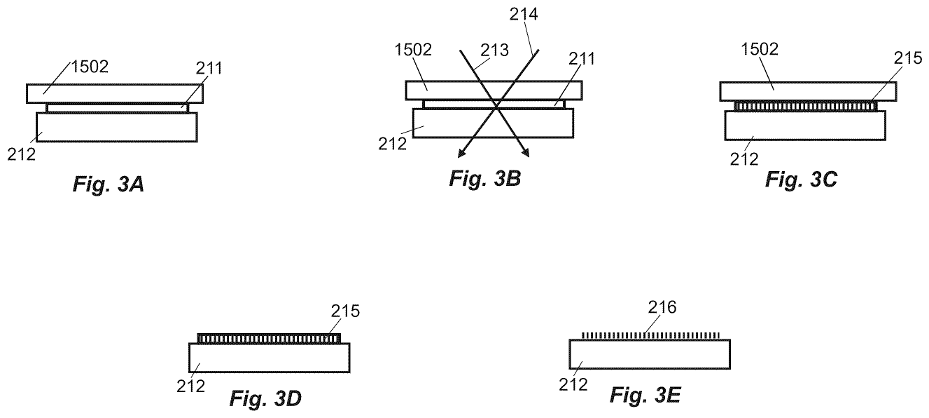

FIGS. 3A-3E illustrate an example process flow for fabricating deep SRGs in accordance with an embodiment of the invention. In FIG. 3A, a pair of substrate 212, 1502 sandwiches an unexposed holographic mixture layer 211. The pair of substrate 212, 1502 may include a base substrate 212 and a cover substrate 1502. The cover substrate 1502 may have different properties than the base substrate 212 to allow for the cover substrate to adhere to the unexposed holographic mixture layer 211 while capable of being removed from the formed the volume grating after exposure. The holographic mixture layer 211 may include monomers and an inert material.

In FIG. 3B, the holographic mixture layer 211 is exposed by a pair of holographic recording beams 213, 214. As illustrated in FIG. 3C, the holographic recording beams 213,214 expose the holographic mixture layer 211 to form a volume grating 215. The monomer and the inert material may phase separate and the monomer may convert into polymer such that a volume grating 215 is formed. The volume grating 215 may include alternating polymer rich regions and inert material rich regions. In FIG. 3D, the cover substrate 1502 may be removed exposing the volume grating 215. The cover substrate 1502 may be removed allowing the volume grating 215 to remain on the base substrate without damaging the volume grating 215 during removal.

As illustrated in FIG. 3E, the inert material may be removed or evacuated from the inert material rich regions between the polymer rich regions leaving air regions. The polymer rich regions and the air regions form polymer-air SRGs 216.

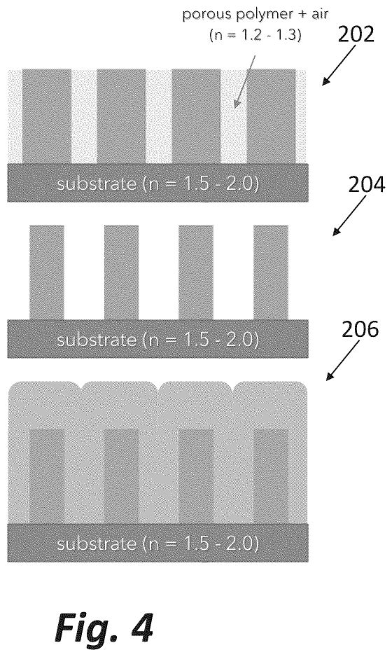

FIG. 4 is a schematic illustration of a backfilling method which may be utilized on the polymer-air SRGs 216 described in FIG. 3E in accordance with an embodiment of the invention. A first phase 202 illustrates a nanostructure configured as an unslanted grating in an initial stage. Fabrication of the grating of the first phase 202 may be achieved through the steps described in connection with FIGS. 3A-3E. The grating in the first phase 202 may correspond to the polymer-air SRGs 216 described in connection with FIG. 3E. The nanostructure includes polymer rich regions separated by regions containing residual polymer. The residual polymer may be a weak polymer network immersed in air. The polymer-rich index may have an average index of 1.5 while the residual polymer regions may have an average index of 1.2-1.3. The substrate may have a refractive index in the range 1.5-2.0. The thickness of the nanostructure may be 400 nm. A second phase 204 illustrates the nanostructures after an etching step with the residual polymer network removed. The etching step may be a plasma etching step. A third phase 206 illustrates the nanostructures after a backfilling has been performed. The backfilling may be a coating process which may involve a deposition of Silicon Nitride (Si₃N₄). The deposition may be performed via ALD or PECVD. A SiN layer coats the polymer grating and may have a refractive index of 2.0. The SiN layer may be deposited with a thickness of 200 nm over the polymer grating at 90° C. The deposition time may be around 100 seconds.

Backfilling of a grating structure with SiN provides several important benefits for waveguide display including EPS gratings. For example, the effective index of the EPS structure can be increased to support FoV of 50 degrees and beyond. The SiN backfill may forms a diffusion barrier against oxygen and moisture which may protect the grating. The SIN backfill may act as a high hardness and solvent resistant coating that can withstand scratching and cleaning. The SiN may have high thermal conductivity which may provide high heat and thermal shock resistance.

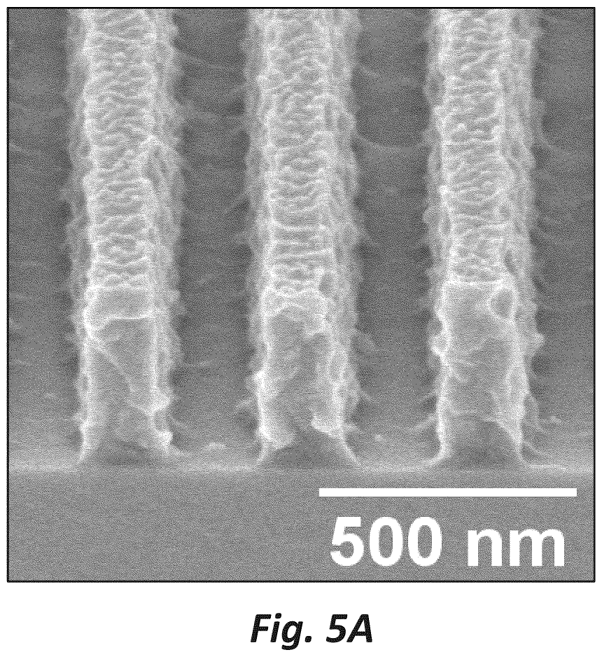

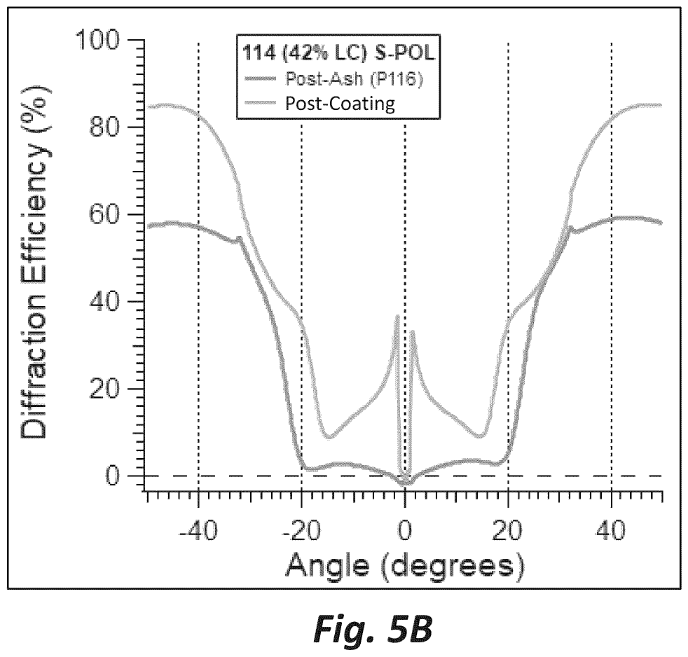

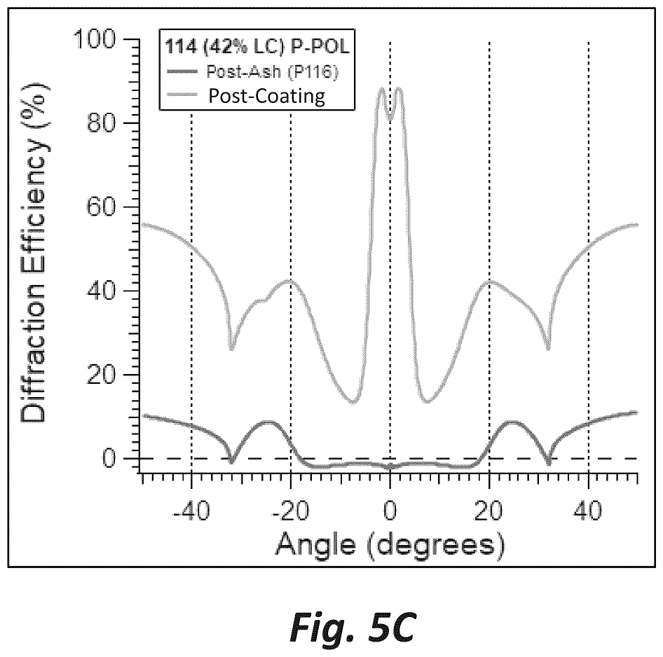

FIG. 5A is an SEM image of an example post-ashed EPS grating. The EPS grating is initially recorded using a holographic mixture containing 42% LC. FIG. 5B is a diffraction efficiency (DE) versus angle plot for S-polarized light. FIG. 5C is a DE versus angle plot for P-polarized light. The DE plots each provide curves for the DE immediately post ashing as illustrated in FIG. 5A and after deposition of SIN. As illustrated the diffraction efficiency significantly increases due to the SiN deposition.

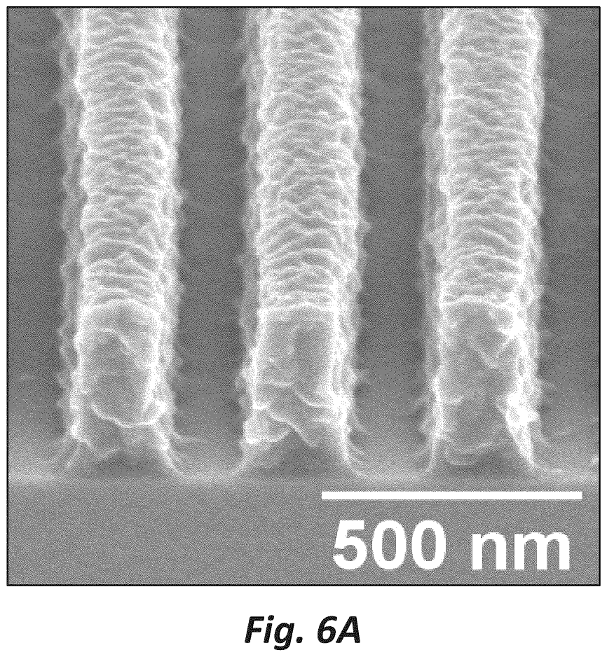

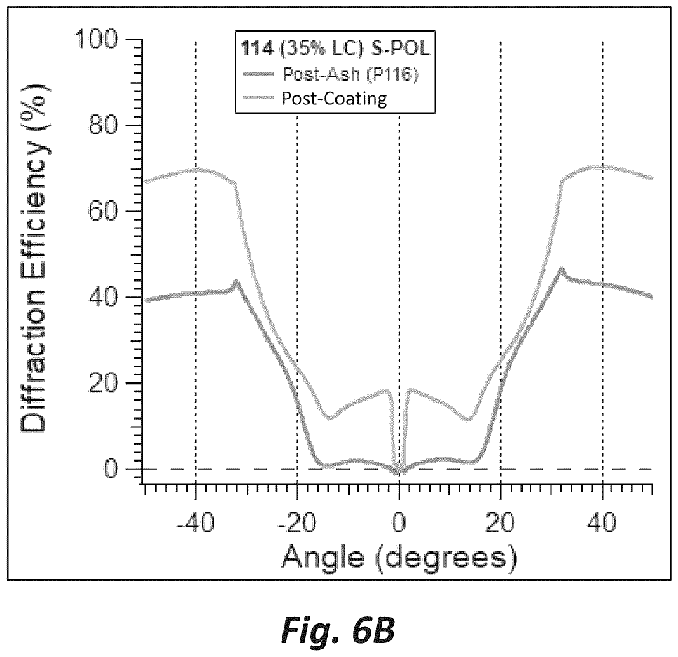

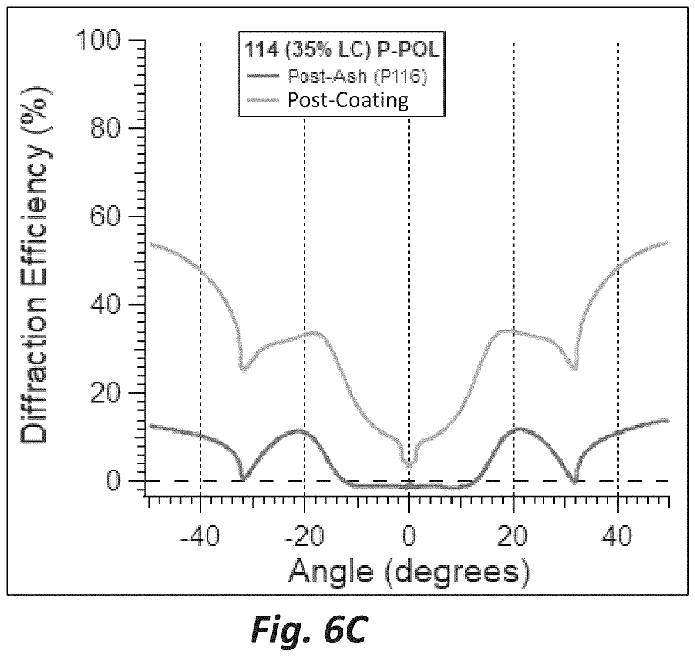

FIG. 6A is an SEM image of an example post-ashed EPS grating. The EPS grating is initially recorded using a holographic mixture containing 35% LC. FIG. 6B is a DE versus angle plot for S-polarized light. FIG. 6C is a DE versus angle plot for P-polarized light. The DE plots each provide curves for the DE immediately post ashing as illustrated in FIG. 6A and after a deposition of SiN onto the post ashed grating. As illustrated the diffraction efficiency significantly increases due to the SiN deposition.

FIGS. 5A-5C and FIGS. 6A-6C compare EPS gratings made using different LC concentrations (42 wt % vs 35 wt %). As illustrated, the high LC concentration of the gratings of FIGS. 5A-5C result in a higher P-polarization DE after the PECVD deposition of SiN.

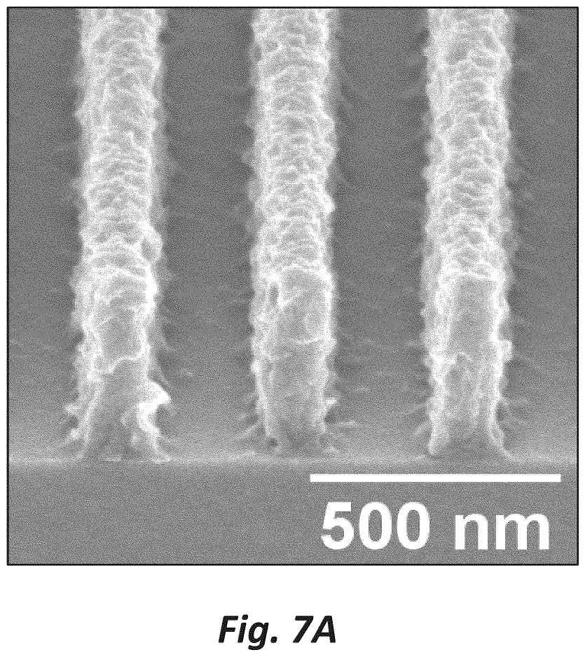

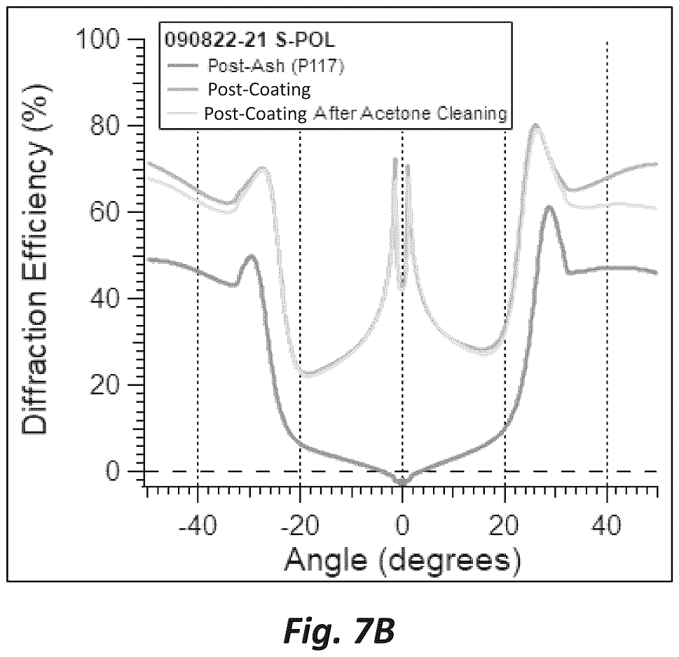

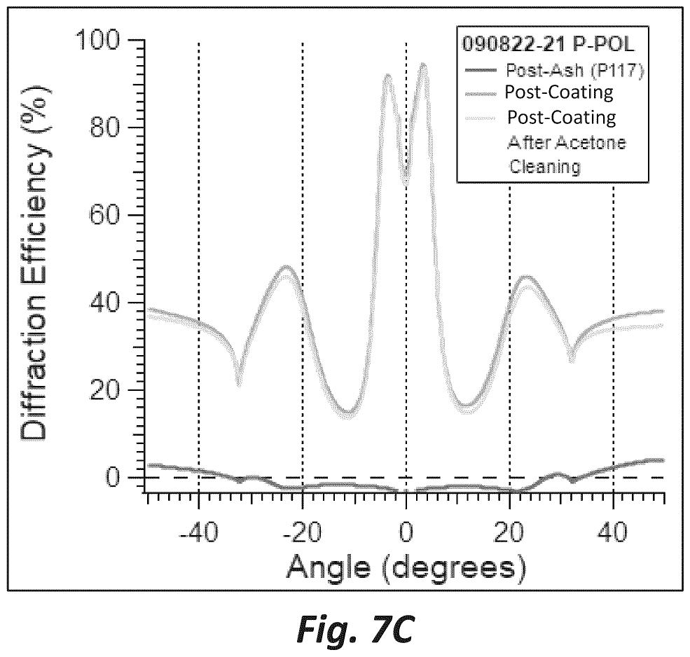

FIG. 7A is an image of an example grating. This grating was recorded with the process described in connection with FIG. 1. Further, a post processing acetone cleaning after the coating step is performed. FIG. 7B is a DE versus angle plot for S-polarized light of the grating of FIG. 7A. FIG. 7C is a DE versus angle plot for P-polarized light of the grating of FIG. 7A. As illustrated, there is small impact on DE with an acetone cleaning after the coating process.

The DE plots each provide curves for the DE immediately post ashing as illustrated in FIG. 7A, after PECVD deposition of SIN, and then after a subsequent acetone cleaning. The acetone cleaning may be performed with a soft wipe. As shown in FIGS. 7B-7C, there may be no significant change to the DE after cleaning of the nanostructure using acetone applied with a soft wipe.

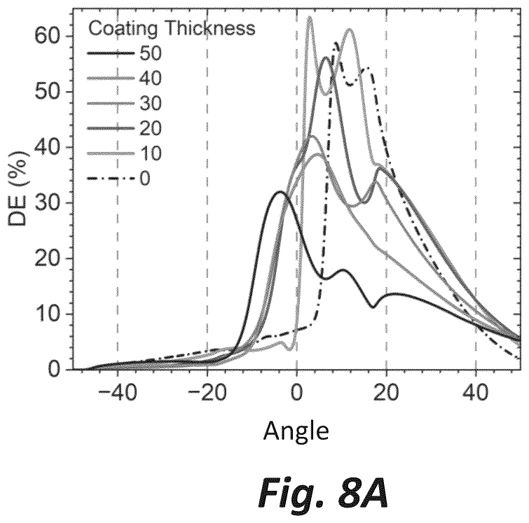

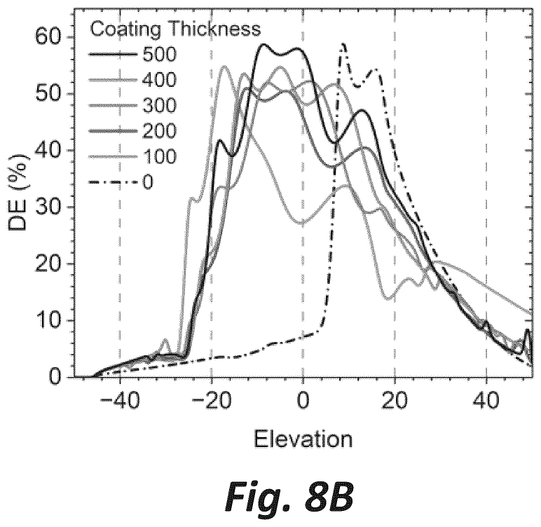

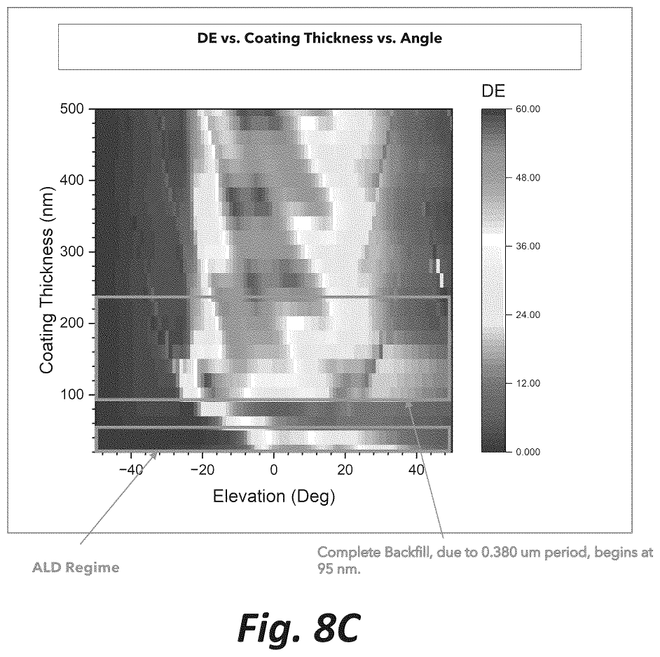

FIGS. 8A-8B are various plots of DE versus angle for a slanted grating backfilled EPS design. The backfill may be a SiN backfill. The different plots correspond to different coating thicknesses. The coating thicknesses are all noted in nanometres. The DE is computed for an LED source operating over the green band. FIG. 8A shows the percentage DE across versus angle for an ALD coated grating for ALD coating thicknesses in the range 0 -50 nm. FIG. 8B shows the percentage DE across versus angle for an PECVD SIN coated grating for ALD coating thicknesses in the range 0 -500 nm. FIG. 8C is a graph that aggregates the coating thickness versus angle characteristics in the ALD regime and in the SIN PECVD regime for a completely backfilled grating. The structure may include a surface substrate refractive index of 2.0; a fill ratio of 0.5; a slant angle of 25 degrees; polymer thickness of 0.5 micron, grating period of 0.38 micron, polymer index of 1.5 and coating index of 2.0. Note that in the examples of FIGS. 8A-8C, complete backfill (illustrated in the third phase 206 of FIG. 4) occurs when the coating thickness is greater than or equal to 95 nm.

While the SiN backfill method disclosed here offers potentially significant benefits including increase of the effective refractive index of grating structures and, in the cases of displays, increasing the field of view. PECVD-depositing SiN strengthens and increases the environmental robustness of grating structures. PECVD may be faster and more economical than ALD deposition. There are some significant, but potentially manageable risks associated with the use of PECVD. Thick layers (e.g. >100 nm) of SiN may not cause significant haze. Thick layers (e.g. >100 nm) of SiN may not cause significant transmission losses. Thick layers of SIN may, potentially, cause strong reflections (and thus losses). However, the effects of any reflections may be ameliorated by well-designed AR coatings. Since the proposed methods relies on backfill, the uniformity of PECVD compared to the conformality of ALD may not be a major issue.

In many embodiments, a top substrate may function as a release layer. In many embodiments, a further step of removing the release layer after curing of the nanostructure may be performed. The release layer may be used in a multilayer fabrication process as discussed in Int. Pub. No. WO 2022/187870 entitled “Evacuated periotic structures and methods of manufacturing” and filed Mar. 7, 2022, which is hereby incorporated by reference in its entirety. WO 2022/187870 further discloses different release layers. In many embodiments, a release layer may perform the dual functions of a removable adhesive layer and a layer including a modified surface configured to influence aspects of the formation of the nanostructure.

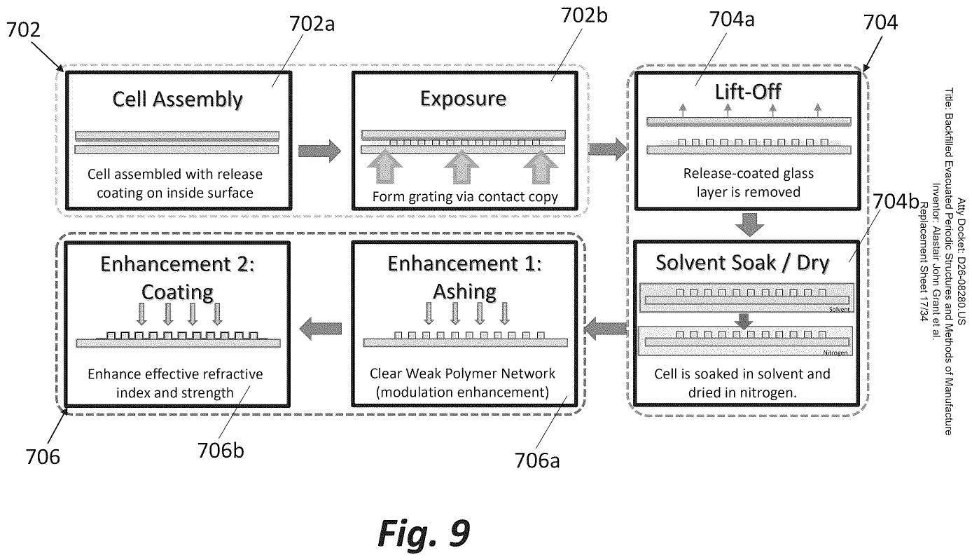

FIG. 9 illustrates an example nanostructure fabrication process in accordance with an embodiment of the invention. At a first step, there is an exposure process 702. During the exposure process 702, a cell assembly 702a is created including a holographic mixture layer sandwiched between a bottom substrate and a top substrate. The top substrate may include a release surface which may be coated with a release layer. The release surface contacts the holographic mixture layer. The cell assembly 702a may be exposed 702b which a holographic exposure process to form a holographic grating. After the exposure process 702, an evacuation process 704 may be performed to form an EPS. After exposure, there is polymer rich regions and inert material rich regions. In this process, the top substrate is lifted off 704a the holographic mixture. The release layer may facilitate the removal of the top substrate from the holographic mixture. The grating may be subjected to a solvent soak 704b. The solvent soak may remove the remaining inert material from the inert material rich regions and the polymer rich regions. The cell may be dried from the solvent. In some embodiments, the cell may be dried using a nitrogen drying process.

After the evacuation process 704, the EPS may be subjected to various EPS enhancement processes 706. An ashing process 706a may be used to clean weak polymer networks which may enhance performance. In a further step, a thermal reflow (not shown) may be used to modify the geometry and surface quality of the etched features (e.g. modifying slant angles). The thermal reflow process may include heating the polymer past its glass transition temperature. When heated over its glass transition temperature, the polymer changes into a viscous state. A surface of least energy (e.g. surface of minimum area) is formed under surface tension forces. This process typically occurs at high temperatures but may also take place at moderate temperatures if the polymer melt is sufficiently viscous. In many embodiments, the reflow may result in a curving of the faces of the polymer structure. The resulting curved diffractive elements may expand the angular response of the grating structure.

Further, a coating process 706b may be used to coat the ashed grating with a coating. The coating process 706b may be an ALD process. The coating process 706b may deposit a coating such as a SIN coating. The coating process 706b may enhance effective refractive index and strength.

The coating process may include depositing at least one layer of high index material onto the polymer structure using a dry deposition process. Different inorganic materials may be deposited in different layer thicknesses. The coating process may include a liquid deposition process Using a liquid deposition process, a resin-based high index material may be deposited onto the structure formed by the dry deposition process. Different configurations of high index materials may be formed by applying and dry and liquid deposition in different orders. Fabrication of a given waveguide design may use different deposition schemes based on different dry and liquid deposition schemes and different high-index materials to meet the differing grating prescription requirements of input, fold and output gratings. In many embodiments, the immersion/coating with high-index material will result in at least one of reduced surface roughness, higher effective refractive index and planarization. Waveguides incorporating immersed gratings may benefit from reduced eyeglow. In many cases, the diffractive structure resulting from immersion may benefit from the high contrast between the high refractive index material between polymer fringes which may be of lower refractive index.

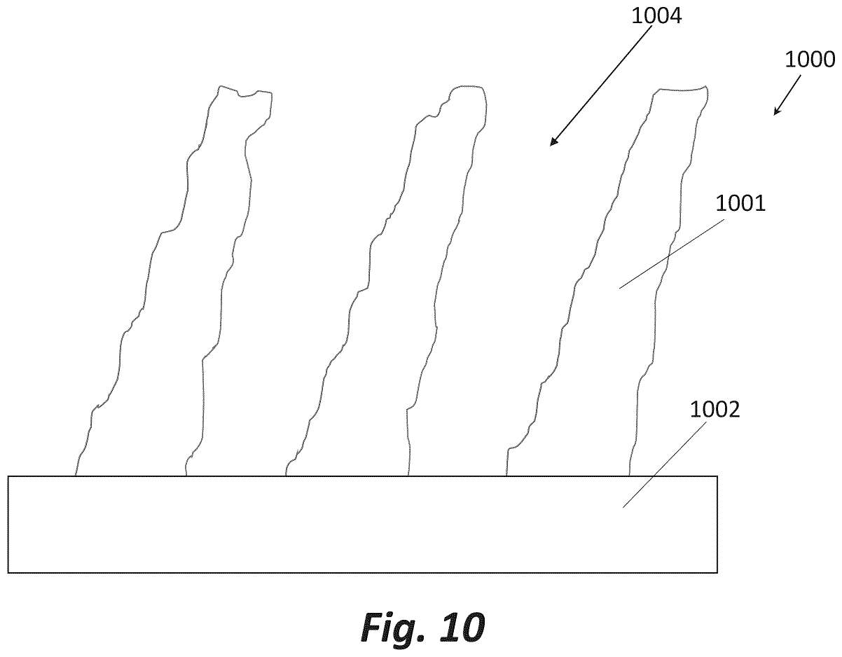

FIGS. 10-21 conceptually illustrate, in cross section, configurations of immersed gratings. Coating thicknesses may be exaggerated for the purposes of explanation. Rough surfaces of the polymer grating structure are illustrative and may not accurately represent the actual roughness, which will depend on the holographic recording material, degree of phase separation, etching process efficiency and additional processes such as thermal reflow. As discussed previously, high-index material layers may be deposited on the polymer grating structure using dry deposition processes or liquid deposition processes.

FIG. 10 is a cross-sectional view of a surface relief grating 1000 in accordance with an embodiment of the invention. This surface relief grating 1000 may be manufactured utilized the techniques described in connection with FIGS. 3A-3E or FIG. 9 without the end coating methods. The SRG 1000 includes polymer fringes 1001 supported by a substrate 1002. The polymer fringes 1001 are separated from one another by air gaps 1004. The illustrated polymer structure may be manufactured by exposing a holographic material, removing the inert component from inert material rich regions, etching to remove unreacted material, and cleaning. This SRG 1000 may also be manufactured with other methods such as nano imprint lithography. The SRG 1000 may be a deep SRG with a thickness in the range 1-3 micrometers with a Bragg fringe spacing of 0.35 to 0.80 micrometers. In some embodiments, the ratio of grating depth (thickness) to Bragg fringe spacing may be 1:1 to 5:1. The polymer fringes 1001 is a well defined alternating pattern of polymer regions and air regions. As illustrated, the polymer fringes 1001 may be slanted or unslanted.

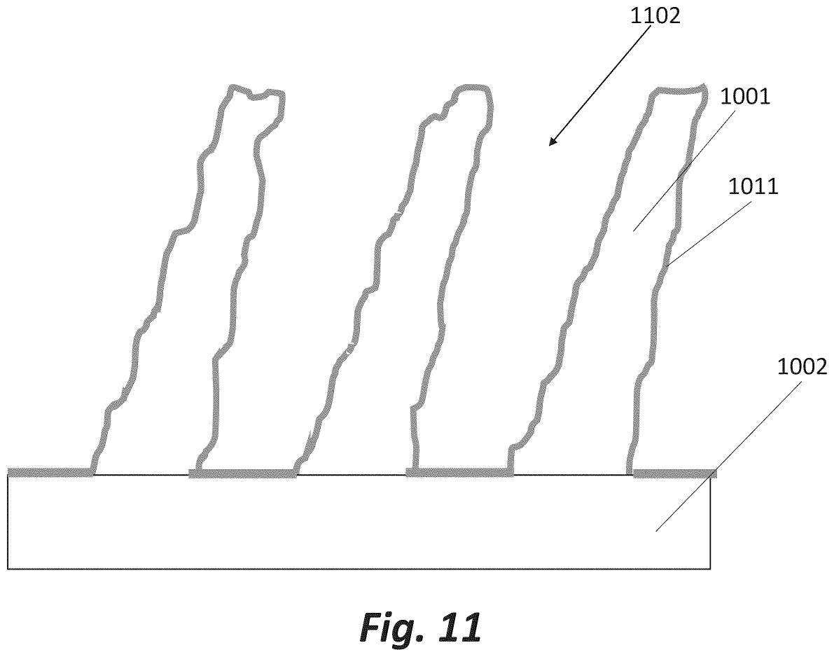

FIG. 11 is a cross-sectional view of the grating of FIG. 10 after a high index coating 1011 has been applied in accordance with an embodiment of the invention. In many embodiments, the high index coating 1011 may be an inorganic material applied using a dry deposition process and the coating thickness may be in the range of 1.5 nm to 100 nm.

The dry deposition process may be atomic layer deposition (ALD), chemical vapor deposition (CVD), plasma-enhanced chemical vapor deposition (PECVD), or metal-organic chemical vapor deposition (MOCVD). The coating process may produce a high index coating 1011 which conformally coats the polymer fringes 1001. The polymer fringes 1001 form a polymer grating. The coating 1011 may be an ALD deposited Al₂O₃, TiO₂, or HfO₂ layer. The grating grooves of the polymer fringes 1001 may be partly immersed with the coating 1011. Thus, air portions 1102 may still be present between the coating 1011. In some examples, the high index coating 1011 may completely fill the grating grooves of the polymer fringes 1001 which may create a flat coating extending above the polymer fringes 1001 with the air portions 1102 completely filled in by the high index coating 1011.

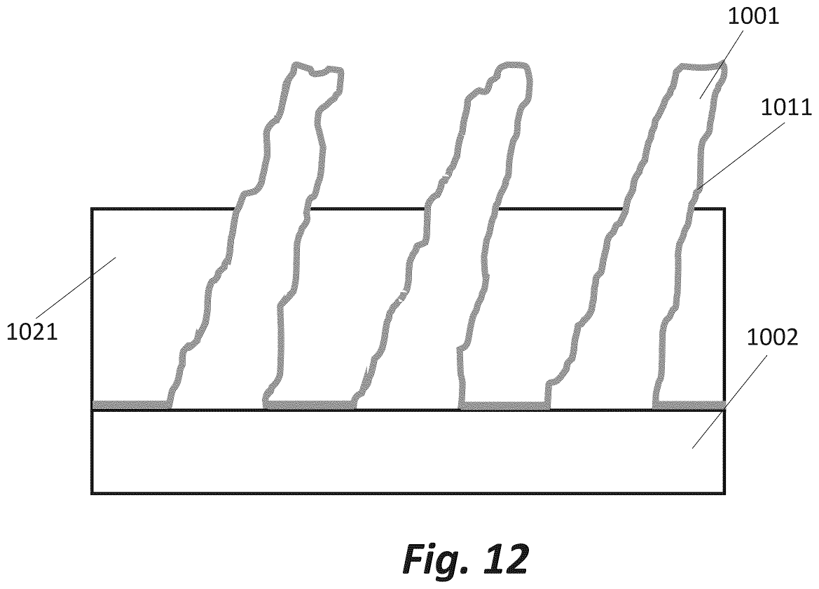

FIG. 12 is a cross-sectional view of the grating of FIG. 11 after partial backfilling with a filling 1021. The backfill material may be a further inorganic material deposited using a dry deposition process. Alternatively, the backfill material may be a resin deposited using a liquid deposition process.

The polymer fringes 1001 which is coated with a high index coating 1011 is described in connection with FIG. 11. An additional high index material may be positioned on top of the high index coating 1011. The additional material may produce a filling 1021 which fills the bottom of the gaps in the high index coating 1011. The filling 1021 may be a high index resin. The high index resin may be applied either in solvent or without a solvent. Various methods may be used to produce the filling 1021. For example, drop-casting may be utilized where a volume of liquid may be dropped on the surface of the high index coating 1011. Also, a spin-coating, slot-die coating, or spray-coating process may be performed. The filling 1021 may fill the grating grooves after a spin-coating and bake process. As illustrated, the filling 1021 and the coating 1011 may be utilized together. In some examples, the filling 1021 may be utilized without the coating 1011 such that the filling 1021 directly contacts the polymer fringes 1001. Further, the coating 1011 may be applied over the filling 1021 such that the high index coating 1011 contacts the top of the filling 1021 and the exposed surfaces of the polymer fringes 1001.

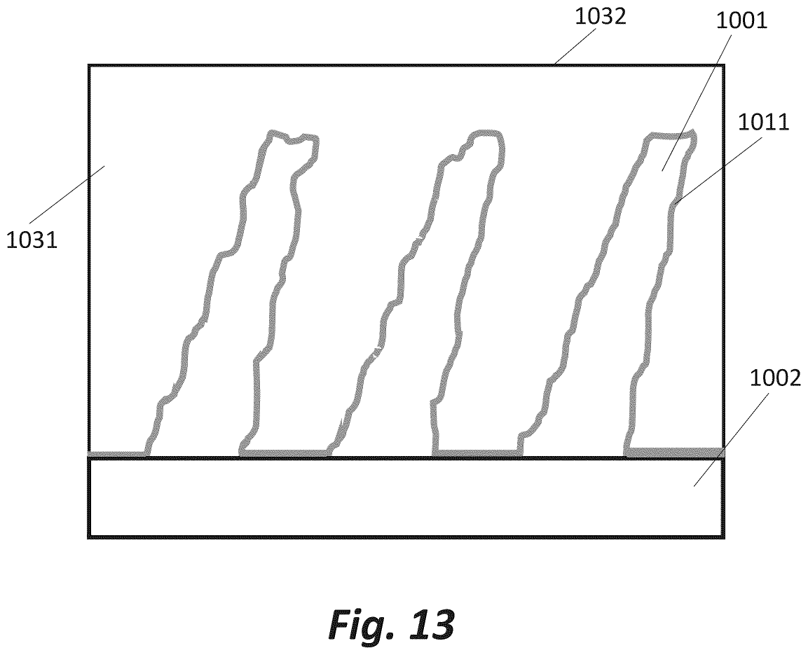

FIG. 13 is a cross-sectional view of the grating of FIG. 11 after totally immersion in the high-index material 1031. In many embodiments, the upper surface 1032 of the second high-index material may provide planarization of the grating structure. This planarization may occur after the deposition of the high-index material 1031 as a separate planarization step or may occur naturally because of the deposition process.

The high index coating 1011 and/or the filling 1021 may have refractive index and thickness to create smooth the sidewalls of the polymer fringes 1001. The high index coating 1011 and/or the filling 1021 may have refractive index and thickness to reduce haze when the polymer fringes 1001 diffracts light. The high index coating 1011 and/or the filling 1021 may have refractive index and thickness to effective refractive index when compared to merely air gaps between the polymer fringes 1001.

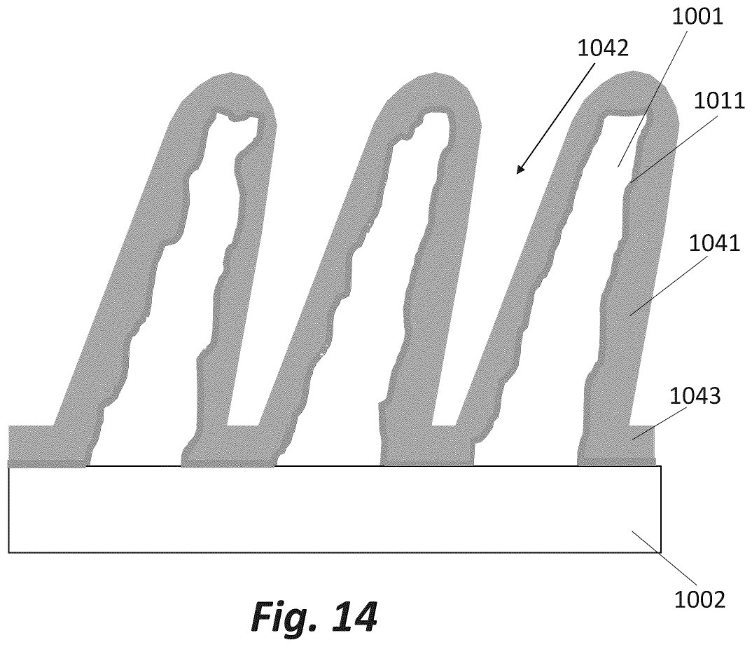

FIG. 14 is a cross-sectional view of the grating of FIG. 11 with the polymer fringes 1001 conformally coated with the first high-index coating 1011, conformally coated with a second high-index material 1041. The resulting structure includes air gaps 1042 between adjacent polymer structures. In many embodiments, the second high-index material 1041 may be a resin (or a resin mixed with a solvent) deposited using a liquid deposition process. The air gap 1042 may extend down to the grating structure pedestal 1043.

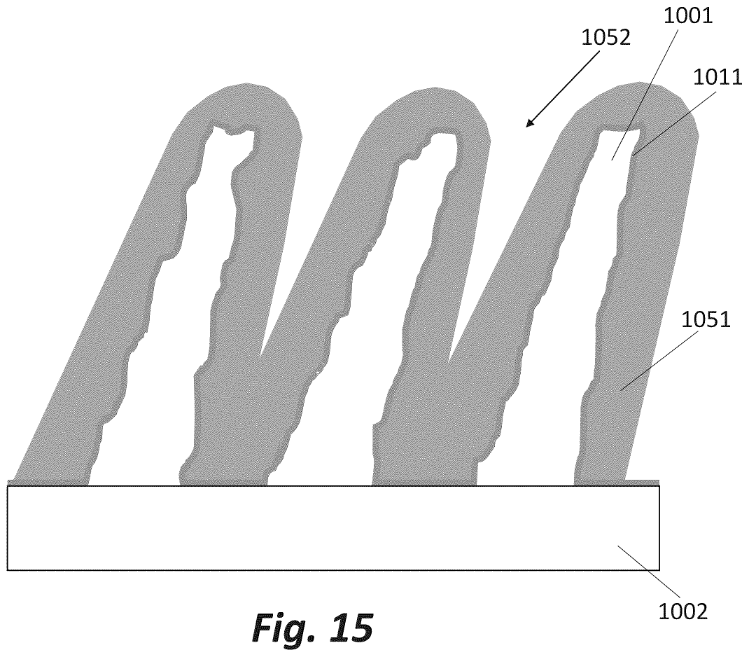

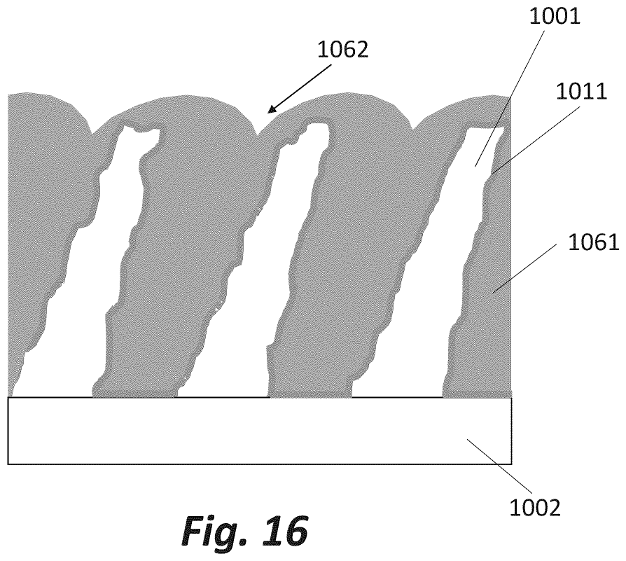

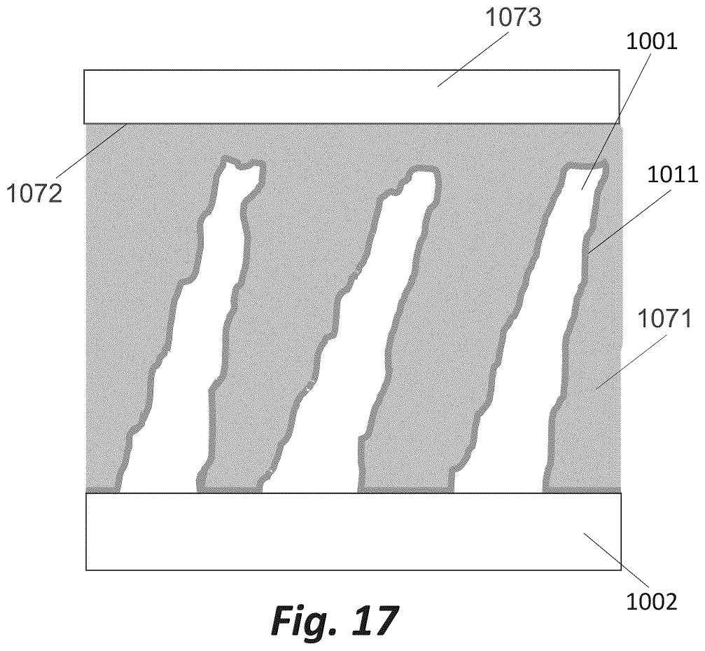

FIGS. 15-17 illustrate further configurations of the second high-index material 1041 of FIG. 14. In FIG. 15, the second high-index material regions 1051 may include reduced air volumes 1052. In FIG. 16, the air volumes between polymer fringes are filled with the second high-index material 1061 resulting in only a surface modulation 1062 of the grating structure. In FIG. 17, the second high-index material 1071 may have a planar surface 1072 which may be bonded to a substrate 1073 or may provide a surface for optical coatings such as AR coatings.

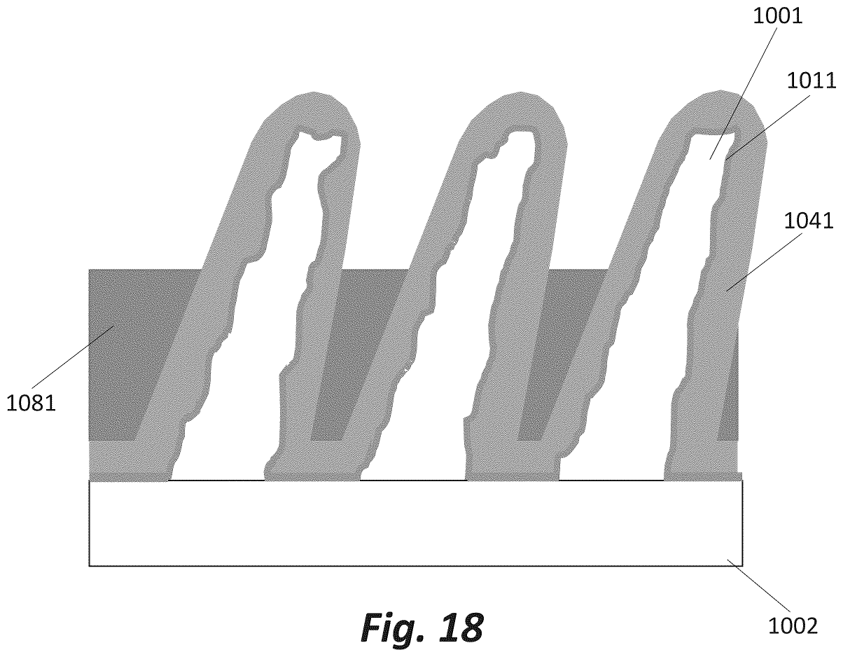

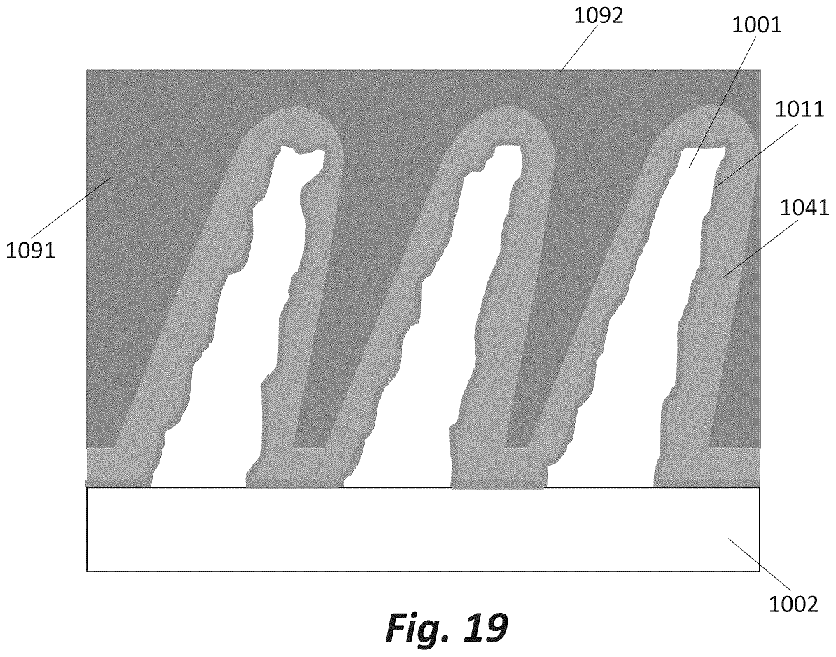

In other embodiments, such as the ones illustrated in FIGS. 18-19, a third high-index material may be deposited after deposition of the first and second high-index materials. The indices of the three materials may be chosen so the indices are in any ratio. In some cases, the material of the highest index may be positioned between the other two materials of lower index. FIG. 18 is a cross sectional view of the grating structure of FIG. 14 that is partially backfilled with a third refractive index material 1081. FIG. 19 is a cross-sectional view of the grating structure of FIG. 14 that is completely immersed in the third refractive index material 1091 which provides a planar top surface 1092 in accordance with an embodiment of the invention.

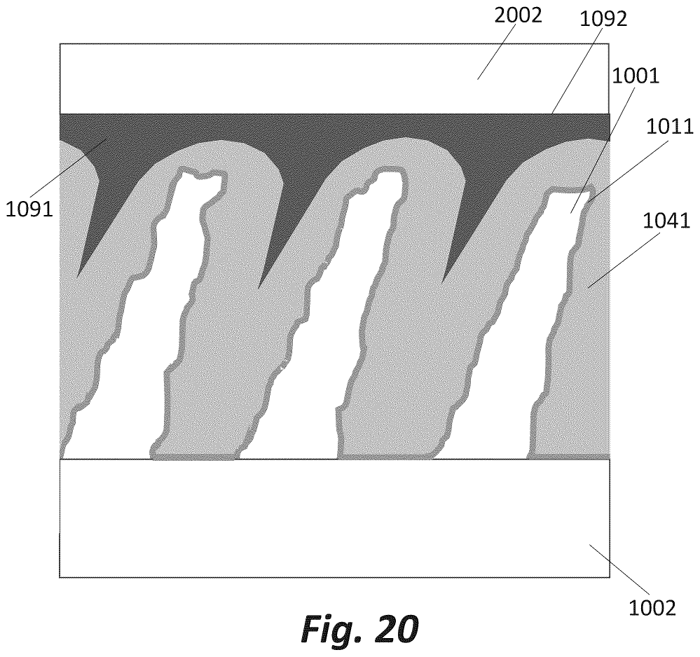

A second substrate 2002 may be positioned on the top of the planar top surface 1092 of the third refractive index material 1091. FIG. 20 is a cross-sectional view of the grating structure of FIG. 19 where a second substrate 2002 is bonded to the planar surface 1092 of the third refractive index material 1091.

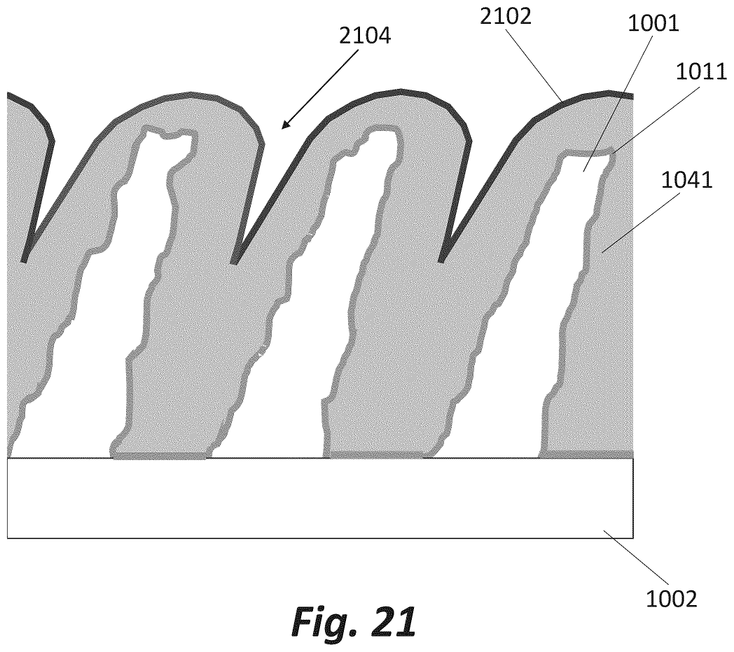

FIG. 21 is a cross-sectional view of the grating structure of FIG. 14 where a third refractive index material 2102 is conformally coated on the second high refractive index material 1041. Air gaps 2104 exist between adjacent portions of the third refractive index material 2102.

Example Including One or More Dry Deposition Processes The high index coating 1011 described in connection with FIG. 11 may be a high refractive index material including one or more layers each in the range of 1 nm to 100 nm. The high refractive index material may be an inorganic material include Al₂O₃, TiO₂, or HfO₂. In some examples, the high refractive index material is HfO₂. The materials may be deposited in more than one deposition cycle.

The high index material can be deposited using various dry deposition methods such as: atomic layer deposition (ALD), chemical vapor deposition (CVD), plasma enhanced chemical vapor deposition (PECVD), and metal-organic chemical vapor deposition (MOCVD). In various embodiments, ALD may employ plasma enhanced spatial ALD which provides more rapid process than conventional (pulse/purge) ALD systems.

In various embodiments, almost complete immersion may be achieved by a thick ALD coated structure. For example, in some embodiments, layers of inorganic high index material may be deposited to form a thick ALD structure comprising a first index layer positioned between two lower index layers. Such structures can be used to increase the effective index of the immersion layer. Such configurations can also be used to smooth out the roughness of the polymer structure. In some embodiments, layers of different high index inorganic materials may be deposited to form a thick ALD in the form of a mixed oxide nanolaminate including alternating layers of the different materials.

The dry deposition may deposit multiple inorganic material layers with each layer having a thickness in the range of 1 nm to 100 nm and refractive index between 2.0 2.2 on a polymer structure of index 1.53 on a glass substrate of refractive index 1.5. The multiple layers may include alternating high and low refractive indices which may provide refractive index optimization and/or smoothing of surface roughness. The smoothing may occur in the sidewall of the polymer structure fringes.

A liquid deposition process (discussed further below) may deposition layer of high refractive index resin of index in the range 1.9-2.0 to planarize the grating structures and bond it to a high refractive index cover of index 1.9. One of the substrate or cover may include a release layer.

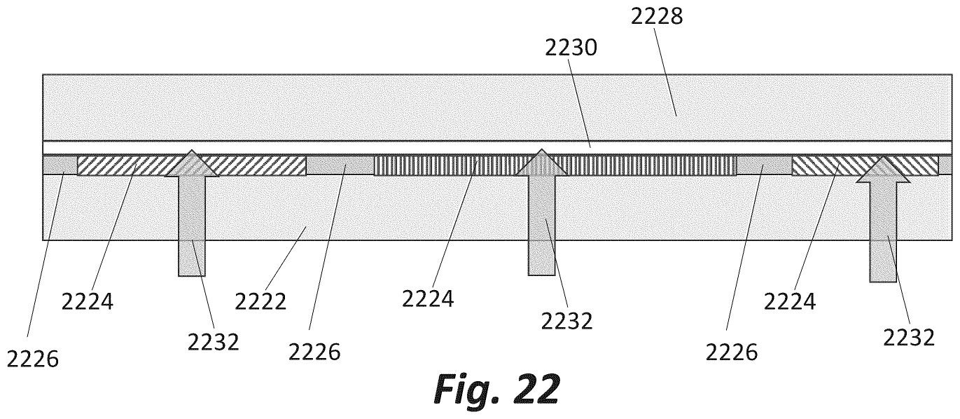

FIGS. 22-24 illustrate three stages of diffractive waveguide fabrication using a dry immersion processes. FIG. 22 illustrates a first stage. A first substrate 2222 includes a holographic mixture 2224 and border regions 2226. A second substrate 2228 including a release layer 2230 may be positioned over the first substrate 2222 such that the holographic mixture 2224 is positioned between the first substrate 2222 and the second substrate 2228. A holographic recording beam 2232 exposes the holographic mixture 2224 through the first substrate. The holographic mixture 2224 may form gratings in a phase separation process. The holographic mixture 2224 includes an inert component (e.g. liquid crystal, inert flued or nanoparticles) and a monomer component. The holographic recording beam 2232 holographically polymerizes and phase separates the mixture to form a volume grating including polymer rich regions separated by inert component rich regions. Different exposure techniques may be applied to each of the regions of holographic mixture to make different types of gratings. For example, the exposure may be performed through a holographic master which has different grating zones with different patterns. The release layer 2230 enables removal of the second substrate 2228 after the gratings have been recorded. The release coating can be applied to any of the two substrates according to recording geometry and which substrate need to be released. The substrates can have any thickness depending on the design but typically they are <1 mm.

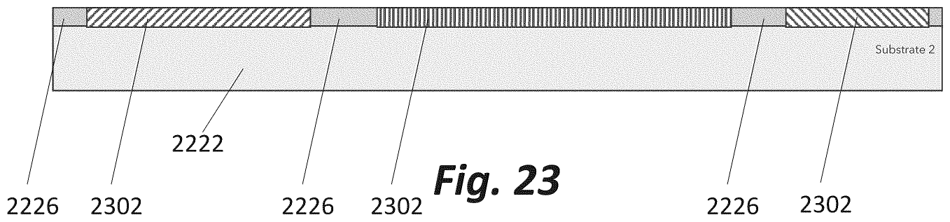

FIG. 23 illustrates a second stage. The second substrate 2228 is released to allow processes for converting the volume grating into an SRG as discussed above. A standard set of fabrication steps is applied to form a well defined surface relief grating 2302 by removing at least a portion of the inert component from the volume grating to form the surface relief grating 2302 including polymer-rich regions separated by air regions. Further processing may include solvent-washing of phase-separated materials and dry etching to clear the grooves of any organic residue.

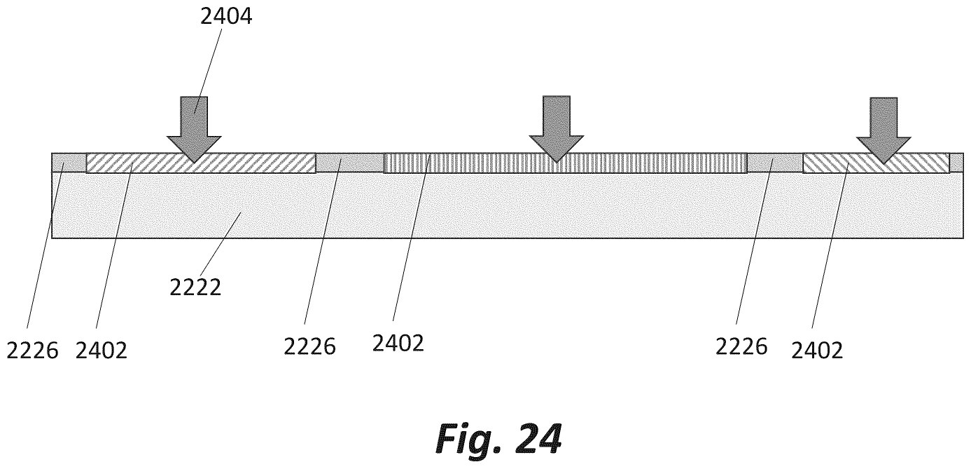

FIG. 24 illustrates a third stage involving the conformal coating of high index material onto the polymer structure. A conformal coating process 2404 may be performed which coats the polymer structure to form a coated polymer structure 2402. The high index coating of the coated polymer structure 2402 may employ be deposited utilizing any of the process steps described above.

### Example Including One or More Liquid Deposition Processes

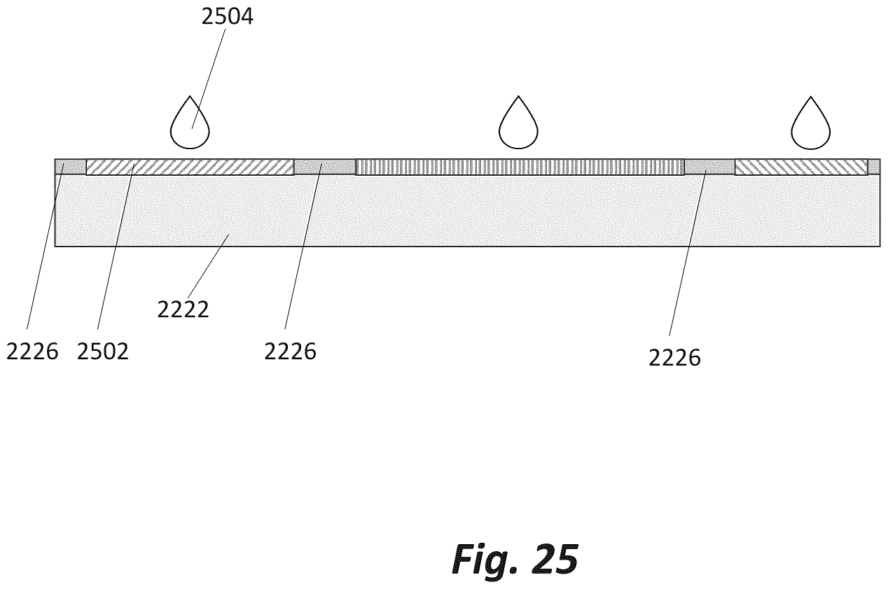

A liquid deposition process may be performed on the polymer structure. The polymer structure may be produced utilizing the steps described in connection with FIGS. 22 and 23. FIG. 25 illustrates a liquid deposition process performed on a grating structure in accordance with an embodiment of the invention. The liquid deposition process 2504 may be performed on the surface relief grating 2302 of FIG. 23 or the coated polymer structure 2402 described in connection with FIG. 24 to form a grating structure 2502.

The liquid deposition process may be drop-casting (dropping a volume of liquid on the surface), spin-coating, slot-die coating, or spray-coating. The liquid deposition process may apply high index material over the entire surface of the grating structure. The coated structure may be encapsulated by bonding to an additional substrate including a release layer. A curing process (e.g. UV curing) is performed to the grating structure. After UV curing, the additional substrate may be released. The planarity of the final structure may be improved by including spacer beads and/or auto-claving. In some embodiments, a resin for deposition may have reduced viscosity by including a solvent which may improve uniformity with spin coating. The liquid deposition process may be performed before or after the dry deposition process. In some embodiments, the liquid deposition process may be performed without the dry deposition process.

The polymer structure may be at least partially filled with a high index resin. The dry deposition process may be utilized after the liquid deposition process to fill in gaps in the high index resin. This may reduce the amount of dry deposition run time. The dry deposition material may fill in cracks resulting from the use of a solution-based high index resin.

In some embodiments, the high index resin layer may be applied to bond the grating structure to a high index substrate. A thin layer of liquid high index resin may be applied to the dry deposition coated polymer structure to planarize the grating surface and bond the grating to a high index substrate. In many embodiments, a thick dry deposition immersion structure may be implemented by at least partially filling the polymer structure via dry deposition and then backfilling the structure with a high index resin.

In some embodiments, the substrates (the first and second substrate illustrated above) may be glass and/or plastic substrates. substrates. After the dry and/or wet deposition processes described in connection with FIGS. 24 and 25, a second (capping) substrate can be added to position the grating structure between the substrates. The second substrate may provide protection for both the grating structure and the eye of the user. The second substrate may increase the effective refractive index of the overall structure by adding a substrate of index higher than that of the grating formation substrate.

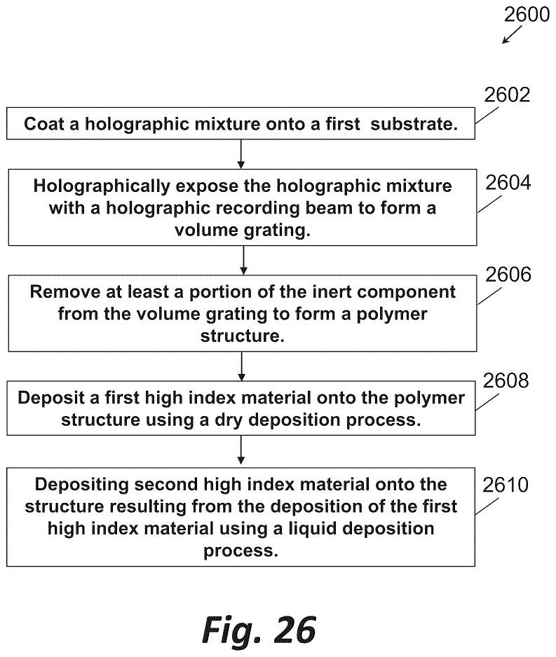

FIG. 26 is a flow chart conceptually illustrating a method of fabricating an immersed surface relief polymer structure in accordance with an embodiment of the invention. The method 2600 includes coating (2602) a holographic mixture onto a first substrate. The holographic mixture includes an inert component and a monomer. The method 2600 further includes holographically exposing (2604) the holographic mixture with a holographic recording beam. The holographic recording beam holographically polymerizes and phase separates the mixture to form a volume grating including polymer rich regions separated by inert component rich regions. The method 2600 further includes removing (2606) at least a portion of the inert component from the volume grating. The resultant grating is an evacuated periodic structure which includes a polymer structure. The polymer structure may be a repeating structure of polymer regions separated by air regions. The method 2600 further includes depositing (2608) a first high index material onto the polymer structure using a dry deposition process.

The method 2600 further includes depositing (2610) a second high-index material onto the structure resulting from the deposition of the first high index material using a liquid deposition process.

A first high index material may be deposited onto the polymer structure using a dry deposition process. A second high-index material may be deposited onto the structure resulting from the deposition of the first high index material using a liquid deposition process.

In many embodiments, the second high-index material may planarize the resultant structure from the deposition of the first high index material on the polymer structure. In some embodiments, a release cover may be applied to the planarizing second high index material. Advantageously, the planarizing second high index material may flatten the top surface of the grating structure which allows for the release cover to sit flush on the grating structure.

In many embodiments, the second high-index material is an organic material including one or more resins. The resins may be mixed with solvents. The second high-index material may be more than one layer of different organic materials of different thicknesses and/or refractive indexes formed in a stack or nano-laminate structure.

In some embodiments, the release cover may include a release layer. Example release layers are disclosed in detail in U.S. Pat. Pub. No. 2022/0283376, filed Mar. 7, 2022 and entitled “Evacuated Periodic Structures and Methods of Manufacturing” which is hereby incorporated by reference in its entirety for all purposes.

### Doctrine of Equivalents

While the above description contains many specific embodiments of the invention, these should not be construed as limitations on the scope of the invention, but rather as an example of one embodiment thereof. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A method for recording a grating structure, the method comprising:
depositing a holographic mixture containing a mixture of monomer and inert material onto a first substrate;
exposing the holographic mixture to a holographic recording beam to form a volume grating comprising polymer-rich regions and inert-material rich regions;
removing the inert material from the inert material rich regions to form an evacuated periodic structure comprising polymer rich regions and regions containing a residual polymer network;
applying an ashing process to the regions containing a residual polymer network to form an ashed grating comprising polymer-rich regions and air regions; and
depositing a coating material onto the ashed grating to form a coated grating where the coating material at least partially backfills the air regions and coats the polymer-rich regions.

2. The method of claim 1, wherein the coating material has an index greater than that of the polymer.

3. The method of claim 1, wherein the coating material is a composite of more than one material.

4. The method of claim 1, wherein depositing the coating material comprises more than one coating steps.

5. The method of claim 1, wherein the coating material includes nanoparticles.

6. The method of claim 1, wherein the coated grating is a slanted grating.

7. The method of claim 1, further comprising depositing an antireflection coating to the coated grating.

8. The method of claim 1, wherein depositing the coating material comprises an atomic layer deposition (ALD) process.

9. The method of claim 1, wherein depositing the coating material includes suffusing a portion of the coating material into pores contained within the polymer rich regions.

10. The method of claim 1, wherein the coated grating comprises a volume phase grating (VPG) comprising alternating polymer-rich regions and coating material rich regions overlaid by a surface relief grating (SRG) formed from the coating material, wherein maxima of the SRG overlay the polymer rich regions of the VPG and wherein minima of the SRG overlay the coating material rich regions of the VPG.

11. The method of claim 1, wherein a surface of the first substrate contacting the holographic mixture is modified by at least one selected from the group consisting of:
nano-structuring, chemical functionalisation, and coating.

12. The method of claim 1, wherein the coating partially backfills the air regions such that a portion of the air regions still exists between adjacent portions of the coating overlaying adjacent polymer rich regions.

13. The method of claim 12, wherein the coating contacts the first substrate in sections between adjacent polymer rich regions.

14. The method of claim 13, further comprising depositing a backfill material above the coating contacting the first substrate in sections between adjacent polymer rich regions to backfill the air regions between adjacent portions of the coating.

15. The method of claim 14, wherein the backfill material partially backfills the air regions between adjacent portions of the coating such that air regions still exist between adjacent portions of the coating above the backfill material.

16. The method of claim 15, wherein the backfill material comprises a high index resin.

17. The method of claim 16, wherein depositing the backfill material comprises drop casting, spin coating, slot-die coating, or spray-coating.

18. The method of claim 17, further comprising curing the deposited backfill material.

19. The method of claim 12, wherein the coating comprises an inorganic material.

20. The method of claim 19, wherein the coating comprises Al₂O₃, TiO₂, and/or HfO₂.
